(19) United States
(12) Patent Application Publication
(10) Pub. No.: US 2013/0301781 A1
(43) Pub. Date: Nov. 14, 2013

(54) MODIFIED DRY ICE HEAT EXCHANGER FOR HEAT REMOVAL OF PORTABLE REACTORS

(71) Applicants: Parviz Parvin, Tehran (IR); Maryam Ilchi-Ghazaani, Tehran (IR)

(72) Inventors: Parviz Parvin, Tehran (IR); Maryam Ilchi-Ghazaani, Tehran (IR)

(21) Appl. No.: 13/470,547

(22) Filed: May 14, 2012

(51) Int. Cl. G21C 15/18

(52) U.S. Cl. CPC G21C 15/18
USPC 376/282

(57) ABSTRACT

A novel heat exchanger (FIG. 1) designed and fabricated based on dry ice-ethylene glycol (DIEG) bath 1 as the coolant mixture for the emergency core cooling system (ECCS) of the nuclear power systems to avoid core meltdown during the normal reactor shutdown or reactor scram in the emergency conditions.

This method is proposed to upgrade the safety systems including modified ECCS which utilizes fast non-water coolant emergency system by fast cooling of reactor pressure vessel (RPV) 31 based on dry ice+ethylene glycol slurry 1.

### REFERENCE TO RELATED APPLICATIONS

The present application claims priority to and incorporates the following applications by reference: Prov. No. 61/287,890 filed on Dec. 18, 2009.

### BACKGROUND OF THE INVENTION

The basic concepts of the chilling systems include mechanical (compression chiller), chemical (absorption chiller) and thermoelectric (Peltier effect) techniques.

There are several disadvantages for the compression chiller such as high electrical consumption, various moving components and need to the regular service and maintenance. Its application is limited to the low and medium cooling units. Conventional compression chillers utilize chlorofluorocarbon (CFC) as an organic compound that contains carbon, chlorine, and fluorine as highly electronegative halogens. The working gas CFC is produced as a volatile derivative of methane and ethane to be extremely hazardous for the ozone layer. Presently, a challenge is being done to replace CFC by the alternative working materials offering new chilling instruments.

Conversely, the absorption chiller offers notable energy saving, high efficiency and smaller size at the expense of the absorber crystallization, high fuel consumption and high first cost. It is mainly suitable for supplying great chilling powers. On the other hand, the thermoelectric device is used to cool the miniature components limited to small volumes. Currently, Peltier effect is vastly used to cool the power transistors and high power laser diodes.

Dry ice heat exchanger is mainly used for fast cooling with a desired temperature stabilization of both coolant and fluid. This instrument has potential to be exploited in the ECCS of the nuclear power reactors.

The cryogenic chilling systems are based on various liquefied gases such as nitrogen (N₂) and helium (He) filled in the dewars or the implementation as liquid-air shower. The liquid carbon dioxide (CO₂) is also used to chill fast the desired materials. Those are categorized as the cryogenic cooling techniques. The problems involve with the liquefied gases include difficult handling and high cooling costs to limit the applications for the medical and the cryogenic research purposes.

### BRIEF SUMMARY OF THE INVENTION

The cryogenic cooling techniques are based on various liquefied gases. Although the liquefied gases such as the liquid phase He (−269° C.), N₂ (−196° C.), Ne (˜−246° C.), and carbon dioxide (−78° C.) are known as the suitable coolants for various applications, among them CO₂ possesses several advantages including relatively low cost, easy handling, simple transportation and the long term preservation. In fact, CO₂ can be permanently kept in liquid phase in a well-insulated reservoir 7 equipped with a simple intra heater and heat exchanger to control the pressure (typically 16-20 Bar). Conversely, the other cryogenic liquids such as N₂ or He lose the inventory inevitably with an appreciable loss rate.

Carbon dioxide as a non-polar molecule possesses a simple structure. It is a colorless gas at ambient condition which can be supplied in both solid and liquid phases. FIG. 4 illustrates the phase diagram of carbon dioxide. Liquid CO₂ 2 diffuses through nozzle 4 at the atmospheric pressure to turn into solid phase (carbonic snow 3) with a density reduction of 1.66 kg/m³ [2]. The carbonic snow 3 is a nontoxic and noncorrosive material.

The latent heat for the sublimation is 573.1 (kJ/kg) which makes it possible to expand up to 800 times of its initial volume. The dry ice cooling power is notably higher than the ordinary ice (wet ice) of the same mass. The non-wetting property of CO₂ sublimation at atmospheric pressure is the major advantage of dry ice.

There are several other advantages using the glycol, including a notable low freezing point as well as significant thermal stability due to the high latent and specific heat properties. Mixing dry ice in ethylene glycol produces slurry 1 with sustainable constant temperatures in the broad range of −19° C.-−40° C. A linear relationship was observed between the slurry temperature and the volume fraction of ethylene glycol for maintaining the desired temperature, provided that a small portion of dry ice is periodically added into the bath 1.

Several experiments were done to study the feasibility of expanding liquid CO₂ 1 into CO₂ solid-gas flow in a horizontal circular tube by the expansion valve 6 and the refrigeration of liquid CO₂ 1 expanding into solid-gas two phase flows in the prototype CO₂ heat pump system [3].

A novel chilling system based on the thermal exchange of water 8 and slurry 1 presents an integrated system to supply large volume of cold water. The core of the system consists of a mixture of ethylene glycol and carbonic snow to cool the hot fluid very fast. The cold fluid is delivered at the steady state temperature due to the high specific capacity of the coolant. The superior advantages of the equipment include fast cooling, temperature independent efficiency and thermal stability. The characterizations of the parameters have been investigated as well. In fact, the heat removal from water occurs during a very short period of time. Subsequently, the heat transfers from water to dry ice to sublimate solid CO₂ into the gas phase due to the latent heat. At the same time, the heat transfers to the glycol of the bath. The temperature reduction continues as far as the solid dry ice is present. Afterwards, the temperature roughly remains constant mainly due to the large thermal capacity of the glycol.

### BRIEF DESCRIPTION OF THE DRAWINGS

The invention will now be described with reference to the accompanying drawings in which:

FIG. 1 is schematics of the proposed dry ice heat exchanger of the present invention;

FIG. 2 is schematic of reactor cooling system [1];

FIG. 3 is diagram of ECCS;

FIG. 4 is a pressure-temperature phase diagram for CO₂ [2];

FIG. 5 is schematic diagram of CO₂ recovery plant of the present invention to convert CO₂ gas into liquid phase;

FIG. 6 is the instantaneous water temperatures at different loading modes with a heat source \dot{Q}=2 kW for V_{R}=1 and T₀=80° C. Note: V_{R} ascertains the fluid to glycol volumetric ratio;

FIG. 7 is schematic diagram of the modified ECCS and RHR 34 units of ECCS during shutdown of power reactors (A) using dry ice heat exchanger in secondary loop (B) direct flooding of slurry 1 into RPV 31;

FIG. 8 is block diagram of modified ECCS to present core meltdown. Right: The modified ECCS based on DIEG slurry 1 leading to safe cold shutdown by two paths i.e., A: cooling by heat exchanger, B: direct slurry 1 flooding into RPV; Left: chain of events after the reactor scram and serious failure in ECCS leading to the core meltdowns and radionuclide release using water as coolant;

FIG. 9 is schematic diagram of the modified ECCS with DIEG loop of the present invention;

FIG. 10 is schematic of hydrogen generation experiments based on hot zircaloy 51 (Zr) in water and slurry; and

FIG. 11 is generation of H₂ (ppm) versus water and slurry temperature of the present invention.

### REACTOR COOLING SYSTEM

On the other hand, the reactor cooling system provides two major functions. Transforming the heat from the reactor to the steam generator (SG) 21 and maintaining the pressure within acceptable limits. Other functions of the system include the heating of the reactor coolant system from the cold or refueling temperature conditions, namely (38-93° C.), and cooling of the reactor from the hot normal operating temperature at 260° C. to the cold, or refueling shutdown temperature.

The reactor cooling system design varies with the reactor type. Pressurized water reactors (PWRs), including VVER and CANadian Duterium Uranium (CANDU) use high pressure piping up to 3000 psia, nominally 1.5 to 3 feet (1.5 to 1 m) in diameter. The coolant pumps for a typical four-loop plant operate at 267° K and 191° K (200° F.).

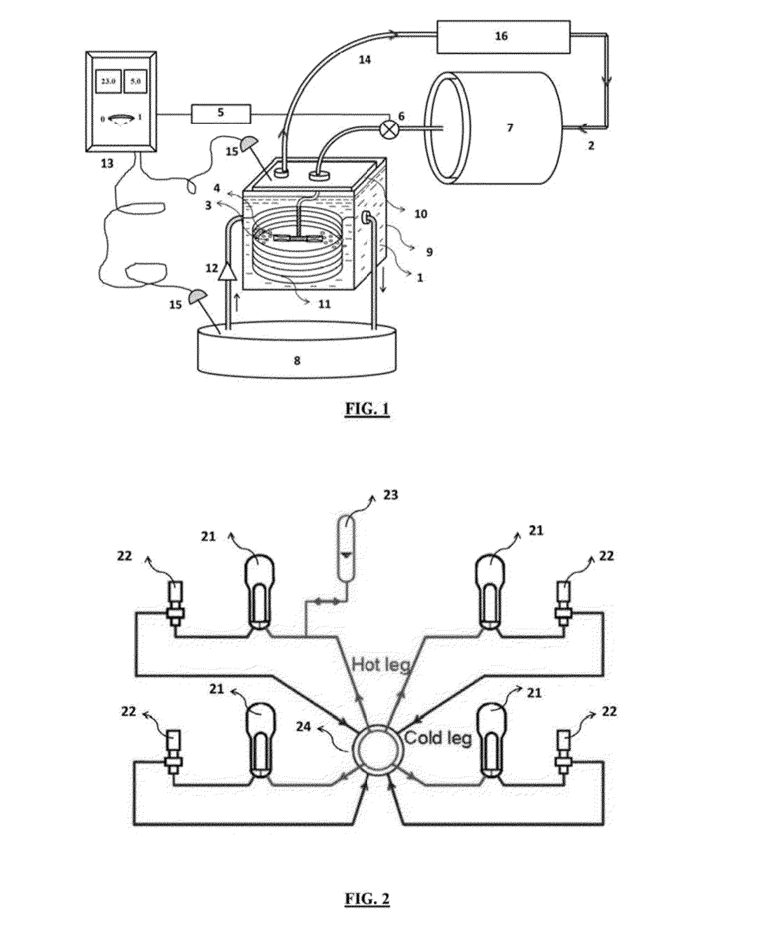

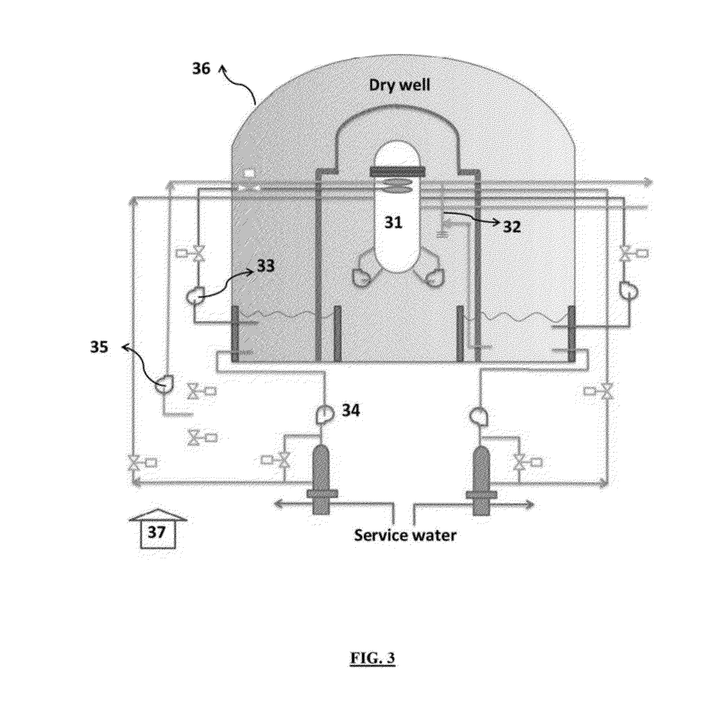

The basic configuration of four-loop reactor cooling system is shown in FIG. 2. The major components in this design include the hot leg connection of reactor to SG 21. The SG 21 at 248K transfers heat from the reactor to the secondary loop and the intermediate leg between the SGs 21 and reactor coolant pump (RCP) 22 at 71K-264K feeds the water through the entire system while the cold leg connects the RCP 22 and the reactor. The pressurizer (PZR) 23 safety valves 32 open automatically to prevent over pressurizing the reactor coolant pipe. In addition, there are usually automatic servo motor operated valves PORV PZR 23 operated relief valve 32 which opens below the set point of the PZR 23 safety valves 32 to provide the reactor protection over-pressurization.

CANDU and VVER designs use a horizontal SG 21 while PWR designs employ a vertical SG 21. The number of loops varies with the reactor type. It may include one or two RCPs 22 per loop. The number of loops varies from two to four loops in different designs.

VVER design have motor operated isolation valves in the reactor cooling loops on both the hot and cold leg sections of the piping. This feature allows isolation of one loop and reduces the likelihood of cooling water loss from the reactor in case of a major loss of coolant accident.

On the other hand, boiling water reactor (BWR) utilizes lower pressure (1500 psia) piping nominally 1.5 to 3 feet (0.5 to 1 m) in diameter. The BWR design allows water to be removed from the reactor for cooling down from the hot (˜325° C.) condition to the cold or refueling (˜38-93° C.) condition. Water can also be filtered to remove chemical impurities and unwanted radioactive materials. Each loop has a single recirculation pump which is used to regulate the power in the reactor. As recirculation pump speed is increased, subsequently, the power is raised.

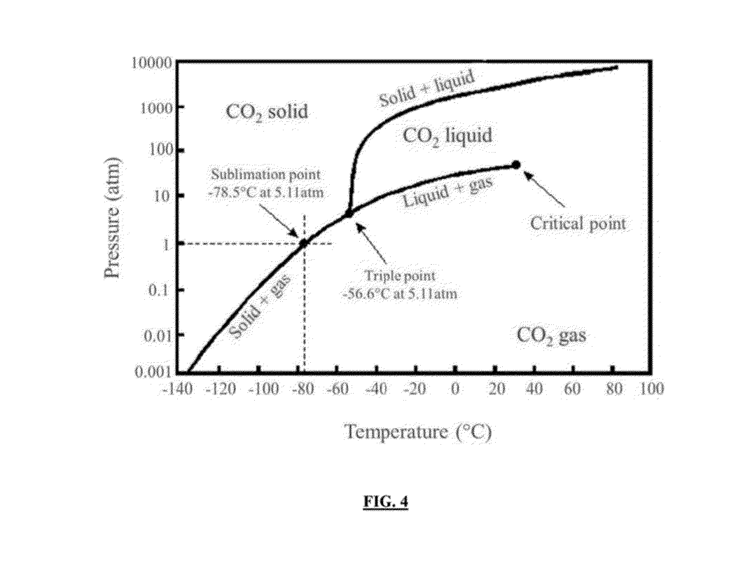

The aggregate of ECCS is designed to protect the reactor core against fuel cladding damage and fragmentation for any loss of coolant accident. In fact, ECCS activates after reactor shutdown or scramming and enforces various safety scenarios and presumptions. FIG. 3 illustrates a typical scheme of ECCS. It is comprised of the low pressure coolant injection function 33 of the residual heat removal (RHR) system 34; the high and low 33 pressure core spray systems; and the automatic depressurization 32 systems. It may be equipped with HPCI (high pressure coolant injection 35 system, RCIC (reactor core isolation cooling) system, HPCF (high pressure core flooder), LPCS (low pressure cooling system 33 and RPS (reactor protection system) as well.

ECCS is designed to perform the following objectives across the entire spectrum of line-break accidents;
To prevent fuel cladding fragmentation for any mechanical failure of the piping system of the nuclear boiler
To provide a protection by using an independent automatically activated cooling system
To function with or without external (off-site) power system

In case ECCS does not function properly during accidents, then the worst critical event i.e., core meltdown will take place leading to the release of fission products and radioactive material into the atmosphere.

The design objectives of the system are:
To restore and maintain, if necessary, the water level in the reactor vessel (RV) 24 following a design basis loss of coolant accident, so that the core is sufficiently cooled and thus to prevent fuel cladding damage and fragmentation
To limit suppression pool water temperature
To remove decay heat and sensible heat from the nuclear boiler system while the reactor is shut down for refueling and servicing
To condense reactor steam so that decay and residual heat may be removed if the main condenser is unavailable (hot standby)
To lead the fuel and reactor containment 33 pools to cool and activate the cleanup system capacity when it is required to provide additional cooling capability.

Following a reactor scram during normal plant operation, the steam generation continues at a reduced rate due to the decay heat of the fission product. The turbine bypass system conveys the steam to the main condenser, and the feed-water system provides makeup water for maintaining the RV 24 water inventory. The RCIC system is automatically initiated to maintain safe standby conditions of the isolated primary system. The turbine-driven pump supplies makeup water from one of the following sources capable of being isolated from other systems i.e. the condensate storage tank 37 (first source), the steam condensed in the RHR 34 heat exchangers (second source), or the suppression pool (an emergency source). The turbine is driven with a portion of the decay heat steam from the RV 24 and exhausts to the suppression pool. The makeup water is pumped into the RV 24 through a connection in the RV 24 head.

The separation of redundant equipment of the various systems that make up the ECCS is maintained to assure optimum operation availability. Electrical equipment and wiring for the engineered safeguard features of the ECCS is divided into segregated sections for further redundancy. The power for operation of the ECCS system is from regular AC power sources. Upon loss of regular power, this switches to the on-site standby AC power sources. In addition the standby diesel-generator is present which is capable of accommodating full capacity low pressure coolant injection and spray function 33. Having its own diesel generator, the high pressure core spray system 35 is completely independent of external power sources.

Although the feed water system under some circumstances is not considered a part of the ECCS, it could either refill the vessel or at least maintain an appropriate water level depending upon the location of any postulated break for a given system of break size. In the case of turbine-driven feed water pumps trouble, this additional coolant source would still be available from the electrically driven condensate pumps.

ECCS is designed to respond to the contingencies if emergencies do happen. The ECCS offers a set of interrelated safety systems that are designed to protect the fuel within the reactor pressure vessel from overheating. These systems accomplish this by maintaining RPV 31 cooling water level, otherwise in the worst condition, by directly flooding the core with the coolant slurry 1.

The present invention offers a novel cooling system based on the thermal exchange of hot fluid (water) and cold slurry 1 including solid CO₂ and ethylene glycol. The core of apparatus is slurry of ethylene glycol and dry ice powder 1 to cool fast the hot water for a long period of operation supplying the steady state working temperature due to the coolant high specific capacity. The superior advantages of the heat exchanger consist of fast and stable cooling respect to the other techniques optimizing the thermal dissipation.

### Theory

The characterizations of the parameters have been investigated. FIG. 1 illustrates the various components of the apparatus. The cold fluid is delivered at the steady state temperature due to the high specific capacity of the coolant. In fact, the heat removal from water occurs during a short period of time. Subsequently, the heat transfers from water to dry ice to sublimate solid CO₂ into gas phase, due to the latent heat. In the same time, the heat transfers to the glycol of the bath and the temperature reduction goes on so far as the solid dry ice is present. Afterwards, the temperature roughly remains constant mainly due to the large thermal capacity of the glycol. Better approximation is done by solving the general heat transfer equation. It follows a sluggish transit time (1/α) obeying the following relation;

T(t)=T₀exp(−λ²αt) (1)

Where, T(t), T₀ and λ show the temperature as a function of time, initial fluid temperature, and the eigenvalue in the general heat transfer equation, respectively.

Let's apply the first thermodynamics law;

du=δW−δQ (2)

Since, there is no significant work exerted on the system (including nozzle arrays), we have;

δQ=−du=ΣMCₚΔT (3)

where, δQ is the total heat flow rate to the system and du denotes the internal energy difference. Furthermore, Cₚ stands for the specific heat capacity. According to FIG. 1, this can be modified to;

Q=M_{w}C_{pw}(T_{w}−T_{0w})−M_{d}L_{d}+M_{g}C_{pg}(T_{g}−T_{0g}) (4)

where M, T and L_{d} denote mass, temperature and dry ice latent heat respectively. Moreover, w, d and g indices stand for water, dry ice and glycol, respectively.

Therefore, the loading mass of dry ice M_{d} is correlated with the corresponding water and glycol masses, by:

$${M}_{d} ( T ) = \frac{1}{{L}_{d}} [ {M}_{w} {C}_{pw} ( {T}_{w} - {T}_{0 w} ) + {M}_{g} {C}_{pg} ( {T}_{g} - {T}_{0 g} ) + δ Q ] \qquad ( 5 )$$

In addition, loading rate can be determined as given by the following equation:

$${\dot{M}}_{d} ( T ) = \frac{1}{{L}_{d}} [ {M}_{w} {C}_{pw} \frac{( {T}_{w} - {T}_{0 w} )}{t} + {M}_{g} {C}_{pg} \frac{( {T}_{g} - {T}_{0 g} )}{t} + \dot{Q} ] \qquad ( 6 )$$

This equation enables us to estimate the optimum loading rate.

The simplest modeling of the heat exchanger consists of a cylindrical system with a single material layer (Cu) having an inner and outer convective fluid flow. In practice, for the dry ice heat exchanger when a mixture of dry ice and glycol is replaced by water, there is no experimental data for the overall heat transfer coefficient Uₒ. To determine the average effective temperature Δ T̅, neglecting the effect of dry ice, we find the heat exchanger equation for water to glycol to be;

$$δ Q = {U}_{o} {A}_{o} \frac{( {T}_{o}^{w} - {T}_{o}^{g} ) - ( {T}_{i}^{w} - {T}_{i}^{g} )}{ln ( \frac{{T}_{o}^{w} - {T}_{o}^{g}}{{T}_{i}^{w} - {T}_{i}^{g}} )} \qquad ( 7 )$$

Hence, for the mixture of dry ice and glycol temperature Tᵢ^{g}, is assumed to be the same as Tₒ^{g} due to notable latent heat of glycol. Therefore, Δ T̅ can roughly be;

$$Δ \overline{T} = \frac{{T}_{o}^{w} - {T}_{i}^{w}}{ln ( \frac{{T}_{o}^{w} - {T}_{o}^{g}}{{T}_{i}^{w} - {T}_{i}^{g}} )} \qquad ( 8 )$$

The experimental value of Δ T̅ can be easily found by measuring the inlet and outlet water and glycol temperatures.

### Apparatus

A practical scheme of a dry ice heat exchanger (FIG. 1) as a fast cooling equipment was designed and fabricated which is based on the mixture of the carbonic powder 3 and the ethylene glycol to create a cryogen bath 1 to attain thermal equilibrium for a long while.

In practice, as an experiment, heat exchanger was fabricated from stainless steel 316 as a cubic box 9 insulated by polyurethane (PU) 10, the helical copper (CU) pipes 11 with ½″ diameter with suitable heat conduction coefficient, κ_{cu}=400 W/(mK) at 27° C. Copper thermal conductivity which is 1.6 times better than aluminum is only inferior to silver. Fluid is circulated through the pipes 11 in a closed loop and return back to the reservoir 8 by a circulation pump 12. The Cu pipe 11 properties such as smooth internal walls, well shaping and flexibility for easy bending as well as the high conduction coefficient assure a suitable heat transfer. The other components such as nozzles 4, valves 6, piping 11, connections and the reservoir were made up of stainless steel 316 as well. Both water 8 and liquid CO₂ 7 reservoirs were insulated with 25 cm thick PU 10. Several digital thermometers 13 were situated to measure the temperature of glycol, fluid, output and ambient temperatures to transfer data to the processing unit. A feedback-control unit 5 keeps the outlet temperature around the set point by adjusting the loading rate or switching off the circulation pump 12. Furthermore, the feedback unit 5 commands the step motor driven liquid CO₂ valve to adjust the flow rate of dry ice dosing into the bath 1. The insulation was perfectly implemented to satisfy the adiabatic condition using PU for the reservoir of the fluid 8.

With this, the heat loss is significantly reduced and the temperature stability improved. The box 9 which contains dry ice+ethylene glycol slurry 1 is insulated with PU 10. However, the sublimation of dry ice causes a gradual increase of the internal partial pressure where a safety valve is installed above the box 9 to release the excess CO₂ gases 14 to attain the system pressure nearly ˜1 atm.

In practice, the cryogen box 9 is coupled with a typical 1000 liters CO₂ liquid tank 7 through an array of nozzles 4 having 1 mm waist diameter. It functions the dry ice powder 3 diffusion into the ethylene glycol with a definite rate to be the integrated version of dry ice heat exchanger where the manual dry ice loading is eliminated and whole loading process is automatic and adjustable.

The proposed integrated system is based on the steady loading which directly converts the liquid CO₂ 2 diffusing through the nozzles 4 into the carbonic powder 3 within the bath 1. Subsequently, the heat transfers from water to dry ice to sublimate the solid CO₂ into gas phase according to the corresponding latent heat. At the same time, the heat transfers to the glycol of the bath and the temperature reduction goes on until the solid dry ice entirely disappears. Afterwards, the temperature is assumed to be constant mainly due to the large thermal capacity of the glycol.

The dry ice heat exchanger was characterized using various loadings. However, the optimum condition strongly depends on the desired working parameters such as steady state fluid temperature, the glycol coolant to fluid volume ratio and the heat rate (\dot{Q}).

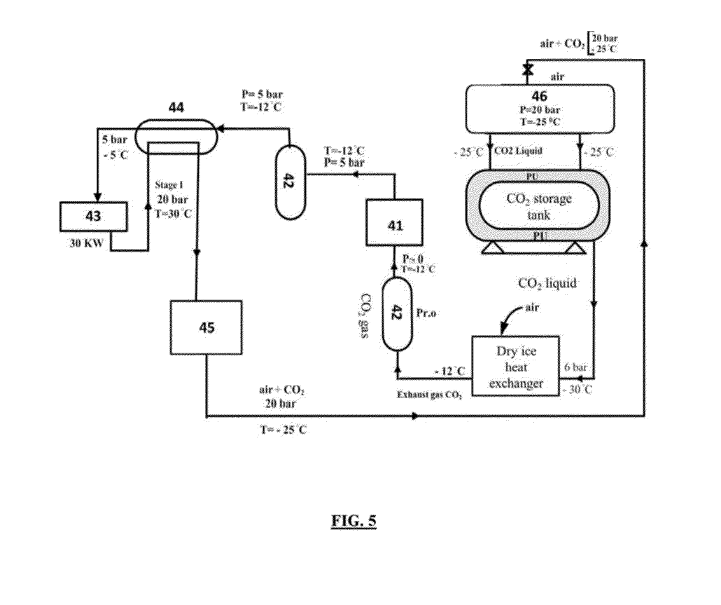

The automatic process improves time wasting manual loading. Instead, the dry ice snow 3 directly is fed into the glycol bath 1. According to the CO₂ thermodynamic phase diagram (FIG. 4), the liquid CO₂ was kept at −78° C. and 16 Bar in the reservoir 7. It flows into the bath at pressure Pₜ which is the atmospheric pressure plus the liquid height in the cold box 1 (Pₜ=P₀+ρgh) to be cooled fast based on the adiabatic cooling where dry ice snow is flushing through the nozzle 4 into the coolant mixture.

According to FIG. 4 at pressures smaller than 6 Bar, the liquid CO₂ turns into the solid debris. When the liquid CO₂ disperses into the fluid or the atmospheric surronding, the dry ice snow is created with higher efficiency and greater heat transfer probability due to the large cross section for the heat transfer. Hence using carbonic snow, water with a typical temperature of 25° C. drops to 1° C. in few minutes.

The system includes several temperature sensors 15 to measure the water temperature. A control feedback unit 5 adjusts the controllable valve 6 driven by a step motor to change the flow rate of liquid CO₂ 2 in order to maintain temperature at a desired value.

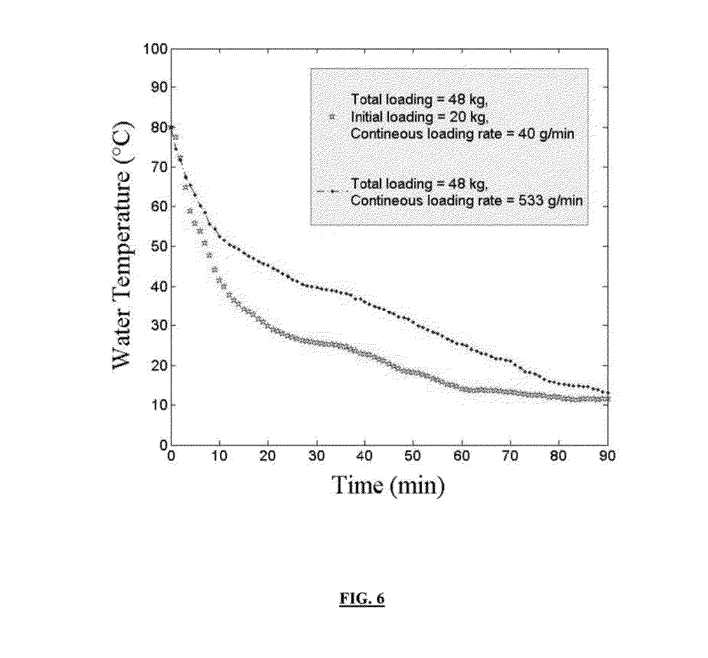

FIG. 5 depicts the CO₂ recovery plant 16 to convert CO₂ gas into liquid. The heat removed from RPV 31 caused to change CO₂ solid into gas at exit of the slurry box 9. While by using a number of equipment such as blower 41, buffer 42, compressor 43 and heat exchanger 44 as well as chiller 45 and condenser 46, the gas is recovered to the CO₂ liquid according to the phase diagram and the thermodynamics states. The CO₂ liquid is collected in the reservoir for further use of modified DIEG in ECCS.

### Open Loop Scheme

Another version of dry ice chiller was designed for the open loop applications to supply spirit (U.S. Pat. No. 6,199,386 B1 issued Mar. 13, 2001 to Michael) and drinking water in high capacity (up to 1 lit/sec) with a desired temperature down to ˜1° C. The fluid enters to the chiller using a small pump and cools down circulating through the bath to deliver cool drinking water at the outlet.

In comparison, closed-loop possesses higher chilling power for a definite V_{R} mostly used as the cooling system in transportation and industries, while the open loop array offers the regular service for dispensable drinking water and spirits or various types of beverages.

The other application is specialized for transportation of live fish, crab as lobster and shrimp by vans in hot summer and tropical climate. It includes supplying cold beverage at inaccessible far rural or remote areas, oil rag sites and religious rallies attending a large number of pilgrims as well as meetings and crowded demonstration with many participants and any gathering such as parades, the exhibitions and fairs.

### DETAILED DESCRIPTION OF THE INVENTION

A thermal source usually generates heat with the definite heat rate (\dot{Q}). Here, as an example, the electrical heater was employed with total resistance R=23.7Ω applying ac voltage (Vᵣₘₛ=220V) which carries current equivalent to Iᵣₘₛ=9.28 A to supply ˜2 kW heat power to the water reservoir 8.

When the heat source is present (\dot{Q}≠0), several loading modes were examined for temperature stabilization. For instance, the water is cooled from 80° C. down to 12° C. using continuous loading rate of 533 g/min at the presence of heat source \dot{Q}=2 kW. FIG. 6 displays the instantaneous water temperatures at different loading modes.

After dry ice loading into the cold box 9, a remarkable water (glycol) temperature drop rate 0.2° C./min (1.4° C./min) took place, while the temperature drop in cryogen bath 1 was significantly greater than that of water (about 7 times). After a while, the water reaches the minimum temperature. This indicates the end of sublimation process within the bath. However, the temperatures approach the isothermal condition after a long period of thermal exchange.

In the bath, the temperature rise rate is nonlinear due to the glycol high specific volume and its temperature dependence as well as the complexity of heat transfer. It also depends on the surrounding temperature. The thermal fluctuations are assumed to be negligible over a long period of monitoring. Furthermore, dry ice heat exchanger is utilized to stabilize the lower temperature of the thermodynamic cycle independent of the environment temperature such that the efficiency remains invariant at various climates. In fact, the heat removal from water occurs within a reduced period of time. Subsequently, the heat transfers from water to dry ice to sublimate solid CO₂ into gas phase based on the latent heat.

### Applications

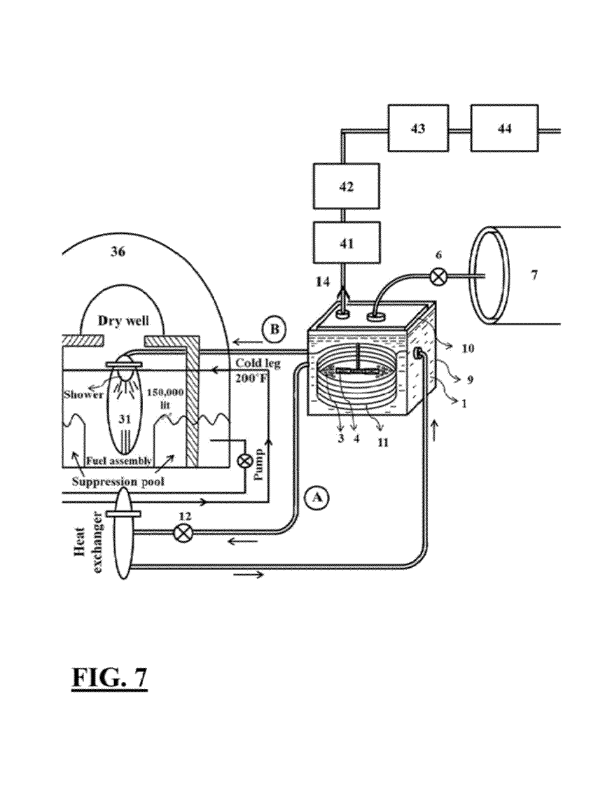

For modified ECCS and a typical ˜6 MW initial residual heat, dry ice heat exchanger (FIG. 7) consumes ˜100 ton CO₂ per day, accompanying the additional CO₂ recovery unit which recovers CO₂ gas into liquid according to FIG. 5. The CO₂ inventory recycles gas to liquid as long as the reactor terminates to a cold and safe shutdown.

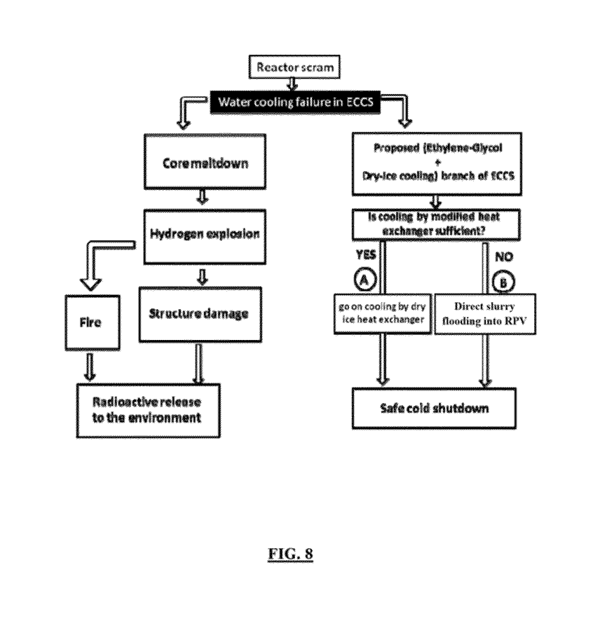

According to FIG. 8 (left), it shows the successive chain of accidents during LOCA leading to the radionuclide release into atmosphere when water is used as coolant. In FIG. 8 (right) the modified ECCS is shown based on Ethylene-glycol+dry ice slurry leading to safe cold shutdown. Two episodes are assumed during LOCA; A: cooling by heat exchanger, B: direct slurry flooding into RPV, (A) ordinary cooling system by water coolant through RHR 34 section of ECCS and (B) modified cooling system using slurry for fast RHR 34 after shutdown. In the case (A), a safe shutdown happens which the fuel assembly will be operable for the electrical utilization later. However in the worst condition prior to the partial meltdown (case B), a direct slurry 1 flooding is recommended instead of flooding sea water into RPV 31. One branch of non-water cooling system of ECCS assures that the core meltdown does not take place even at the worst situations.

In comparison to distilled water, the ethylene glycol has higher boiling point at a certain pressure. Furthermore, according to CO₂ phase diagram at atmospheric pressure, liquid CO₂ converts to carbonic powder 3 when it comes in contact with the ethylene glycol solution in the case of dry ice heat exchanger at pressures below 6 atmospheres. At high pressures ˜100 Bar (BWR) and ˜200 Bar (PWR), the carbonic powder 3 is produced just at the exit of nozzle 4, and again by absorbing the latent heat it turns out to gas. On the other hand, within the pressure range of 100-200 Bar and temperature interval 280-330° C., the CO₂ remains in liquid phase particularly in the case of emergency cooling by direct slurry 1 flooding in RPV 31. Note that the corresponding boiling temperatures of water are 233° C. for BWR and 337° C. for PWR respectively.

It is advantageous to allocate one branch of ECCS for pumping the slurry as a mixture of dry ice+ethylene glycol (C₂H₆O₂), rather than water, not only as a redundant system, but also as a fire extinguisher. If cooling system pumps cease to function properly for instance due to the lack of electricity or a piping break, etc., the dry ice heat exchanger can be exploited for fast cooling of the primary loop, or at emergency situations, by direct flooding of slurry 1 into RPV 31.

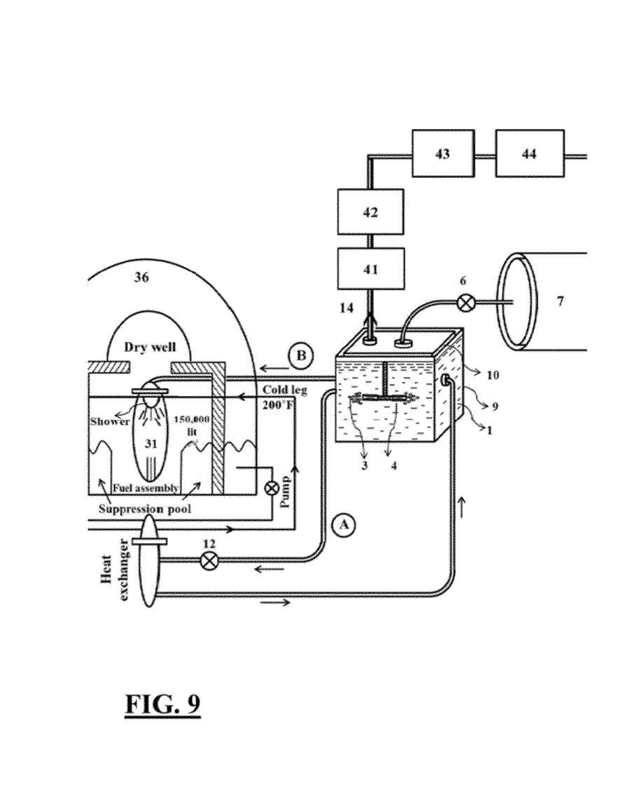

FIG. 9 illustrates the modified dry ice heat exchanger with DIEG loop 1 particularly for prevention of RPV 31 core meltdown in LOCA condition. This might be helpful for ECCS of power reactors to function as a redundant absolute fault proof cooling system without need of electricity.

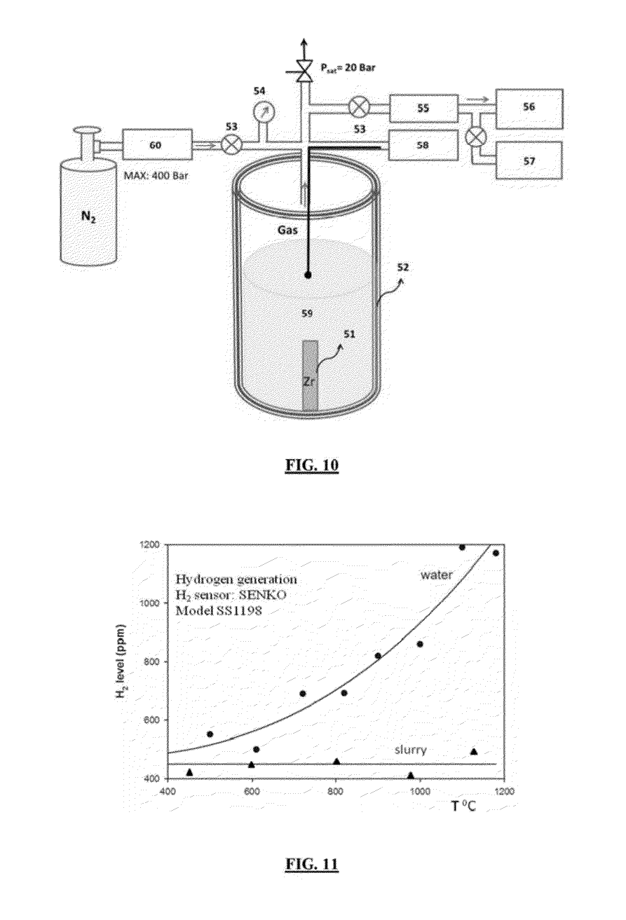

Furthermore, we have performed a series of experiments to verify the cooling feasibility of hot Zr 51 with non-water coolant slurry innovation by means of the instantaneous hydrogen level monitoring. FIG. 10 and FIG. 11 illustrate the schematic of the experiment including monitoring devices to measure hydrogen in ppm level and the generation of H₂ (ppm) versus water and slurry 1 temperature respectively. A series of experiments were performed to determine the quantity of hydrogen generation (ppm) as a function of Zr 51 temperature ranging 400-1000° C. at atmospheric pressures and verifying the performance of slurry 1 to suppress hydrogen generation process.

A cylindrical tube 52 (10 cm dia, 30 cm height) was fabricated from stainless steel having 3 cm thickness to tolerate pressures up to 300 Bar. A safety valve 53 (preset at 25 Bar), a pressure gauge 54, and connection to gas sampling 55 to the gas chromatograph (GC) spectrometer 56 coupled with hydrogen gas sensor 57 (H₂ sensor), were also assembled. A digital thermometer 58 equipped with a thermocouple probe was employed for steady temperature measurements. A piece of Zr 51 block 1 mm×2 cm×1 cm was fixed inside the steel container. The cap was screwed tight on top using special Vitan Orings to seal the container.

Initially ¾ volume of the container was filled with distilled water 59 and the pressure increased to 20 Bar using pneumatic pump 60, then it was heated up to 1200° C. and the hydrogen content above the container was sampled at various certain steady state temperatures. This was followed by similar experiments using the slurry 1 rather than using the distilled water to study any possible hydrogen generation in the pressurized container.

A hydrogen TM SENKO model sensor 57 SS1198 (0-1000 ppm) with 2 ppm resolution was employed to detect H₂ trace roughly in 30 second and also a GC spectrometer 56 Agilent TM model 5975C series GC/MSD was used for the precise hydrogen trace measurement in few minutes. The pressure was limited to 20 Bar using a safety release valve 53. With water filled container, a sharp growth of H₂ was measured at temperatures ranging 500-1200° C., while no significant hydrogen trace was measured in the slurry 1. The superiority of slurry 1 filled container instead of water is the lack of steam generation and better heat transfer to prevent hydrogen generation at the identical conditions.

By using slurry 1, the heat transfer increases many folds to drop the fuel assembly temperature and prevents the fragmentation during LOCA. This technique offers a new method for countering the hazards at the critical conditions using the modified ECCS whereas the solid phase CO₂ acts as the coolant. Even though direct slurry 1 flooding into RPV is not recommended because the fuel assembly would be in operable afterwards, however the use of dry ice heat exchanger as part of ECCS assures the reactor operation after safe shutdown.

The vulnerability of nuclear power reactor and the likelihood of the core meltdown due to residual heat after the scram is a major concern. The core meltdown occurs mainly due to the lack of efficient RHR 34 mainly based on serious failure of ECCS. In fact, the fuel rod temperature rises without sufficient cooling and subsequently non-circulating water boils off at 1600° C. leading to the uncovered fuel rods. Then, the fuel rods melt and drip to the bottom of pressure vessel. In the case of the core meltdown, the radioactive effluent release into the environment and permeates the soil and contaminates the crops nearby. Therefore, the conventional ECCS is suggested here to be redesigned in order to promote the inherent safety features. After Fukushima disaster in Japan, imposing the intensive safety regulations to upgrade the present power reactors is essential to such an extent that the environmental catastrophy no longer takes place. This criterion can be supported by means of a number of innovative safety measures such as the implementation of the modified ECCS. Here, a dry ice heat exchanger for fast RHR 34 is proposed as a non-water cooling systems, to enhance the capability of available ECCS. The non-water cooling system restricts the severe hydrogen production and prevents the consequent explosion which is extremely hazardous during LOCA, to assure the structural integrity. The slurry of carbonic CO₂ and ethylene glycol 1 instead of water coolant in secondary loop is proposed to cool down the fuel rods and level off the rising fuel temperature to the desired value and simultaneously acts as an extinguisher in the case of fire accident leading to prevent the uncover of the cladding. CO₂ recovery plant 16 is also accompanied the modified ECCS to economize CO₂ liquid. The hazard in power reactor always exists even for the reactors that are in cold shutdown mainly because of spent fuel over heating in the storage pool. Therefore, the ultimate level of safety is proposed to implement a system including the direct flooding of slurry 1 into the storage pool too.

A series of experiments were carried out in order to simulate RPV 31 to show superiority of the ECCS using slurry 1 rather than water coolant. In addition the trace of hydrogen in terms of increasing temperature (400-1200° C.) was measured comparing slurry and water as the coolants.

Whereas particular embodiments of the invention have been described above for purposes of illustration, it will be appreciated by those skilled in the art that numerous variations of the details may be made without departing from the invention as described in the appended claims. All references cited are at incorporated in their entirety.

It will be understood that, while presently preferred embodiments of the invention have been illustrated and described, the invention is not limited thereto, but may be otherwise variously embodied within the scope of the following claims. It will also be understood that the claims are not intended to be limited to the particular sequence in which the steps are listed therein, unless specifically stated therein or required by description set forth in the steps.

We claim:

1. A dry ice heat exchanger system comprising a fast cooling substance as slurry and fire extinguisher in a modified emergency core cooling system (ECCS) of a power plant; further comprising a modified heat exchanger for an ECCS of nuclear power plant wherein said system avoids core meltdown during shutdown or emergency conditions.

2. The dry ice heat exchanger system of claim 1, wherein said slurry comprises carbonic snow and ethylene glycol; where said slurry has low electricity consumption during normal ECCS operation after a nuclear reactor shutdown or during accidents such as LOCA, power excursion or after earthquake and tsunami.

3. The dry ice heat exchanger of system of claim 2; wherein flooding of said slurry into a reactor pressure vessel (PRV) is performed instead of sea water in order to prevent worst condition of said core meltdown.

4. The dry ice heat exchanger of system of claim 2; wherein flooding of said slurry into a reactor pressure vessel (PRV) is performed instead of sea water in order to prevent hydrogen generation.

5. The dry ice heat exchanger of system of claim 1; further comprising a CO₂ gas recovery unit for conversion of CO₂ gas into liquid for further use.

6. The dry ice heat exchanger of system of claim 1; wherein said modified ECCS is a safe heat removal of said power plant such as PWR and BWR.

8. The dry ice heat exchanger of system of claim 1; wherein said ECCS is a portable nuclear reactors (such as submarine reactors) to assure safe heat transfer and reliable shutdown.

9. The dry ice heat exchanger of system of claim 5; wherein implementation of said CO₂ recovery unit economizes CO₂ loss during said ECCS operation.

10. A dry ice heat exchanger system comprising a fast cooling substance as slurry and fire extinguisher in a modified emergency core cooling system (ECCS).

11. The dry ice heat exchanger of system of claim 10; comprising an efficient laser chiller for heat removal of optical components such as combiner, fiber and diode lasers of high power kW industrial fiber lasers.

12. The dry ice heat exchanger of system of claim 10; further comprises an efficient laser chiller for water-cooled optical components such as back high power mirror of kW industrial CO₂ lasers for cutting, drilling and welding.

13. The dry ice heat exchanger of system of claim 12; wherein said efficient laser chiller is water-cooled optical components of industrial Nd:YAG lasers.

14. The dry ice heat exchanger of system of claim 11; wherein said efficient laser chiller is cooling of high power diode systems and diode pumped solid state laser (DPSSL) systems and wherein said efficient laser chiller is fast heat removal of high power disk lasers and disk amplifiers and wherein said efficient heat exchanger for said heat removal of said optical components removes heat from conduction mirrors and focusing lenses and/or conduct and deliver high power output beams to its final destination or focusing them on a target.

17. The dry ice heat exchanger of system of claim 1; further comprises a high cooling rate, fast temperature drop as well as temperature independent efficiency and further comprises thermal stability which remains over long period of cooling process due to large heat capacity of said coolant.

20. The dry ice heat exchanger of system of claim 10; further comprises an efficient cooling of hot plates, hot oil and hot water, etc. in various industrial processes and further comprises supplying drinking cool water or other beverages, such as spirits in high capacity particularly in remote and inaccessible areas or demonstration, rally, religious gathering, exhibitions and parades and further comprises a Co2 recovery unit; wherein an implementation of said CO₂ recovery unit economizes CO₂ loss during supplying said cool beverage, spirit or drinking water or said other beverages in high capacity and further comprises an efficient chiller for live transportation of various marine edible creatures such as fish, crab, lobster, caviar and shrimp particularly during hot summer or tropical hot climate and further comprises efficient heat exchanger chilling entrance water of the compressors or similar mechanical devices such as pumps, blowers, etc and further comprises an efficient cooling system in orbital space stations with slight energy consumption which can be supplied by solar cells and further comprises an efficient cooling system for future space colonies being established on Moon, Mars and other planets in a solar system particularly driven by small electrical energy from solar cells.
